(19) United States
(12) Patent Application Publication
(10) Pub. No.: US 2015/0053432 A1
(43) Pub. Date: Feb. 26, 2015

(54) Robotic Roof Ventilation Apparatus

(71) Applicant: Drew R. Davis, St. Petersburg, FL (US)

(72) Inventor: Drew R. Davis, St. Petersburg, FL (US)

(21) Appl. No.: 14/462,800

(22) Filed: Aug. 19, 2014

Related U.S. Application Data
(60) Provisional application No. 61/868,432, filed on Aug. 21, 2013.

(51) Int. Cl. A62C 99/00; E04D 15/00; G05D 1/02; B62D 55/06; B62D 63/02

(52) U.S. Cl. CPC A62C 99/009; B62D 55/06; B62D 63/02; G05D 1/021; E04D 15/003; Y10S 901/01; Y10S 901/41
USPC 169/70; 180/313; 180/9; 180/167; 901/1; 901/41

(57) ABSTRACT

A Robotic Roof Ventilation Apparatus that preforms the process of roof ventilation to protect the lives of firefighters. By keeping the firefighters off the roof of a burning building this robot completely changes the current process of roof ventilation as it provides a reliable way for firefighters to preform roof venation without any risk or loss of life.

### CROSS-REFERENCE TO RELATED APPLICATION

This application is a continuation of U.S. patent application No. 61/868,432, filed Aug. 21, 2013.

### BACKGROUND OF THE INVENTION

1. Field of the Invention

The present invention relates to firefighting apparatuses and, more particularly to apparatuses for roof ventilation.

2. Description of the Prior Art

Roof ventilation is a common practice preformed by firefighters when they arrive at the seen of a fire. The purpose of ventilation is to release heat and smoke from the building which provides better visibility and protects firefighters from backdraft. Backdraft is a burst of flames that occurs when oxygen is introduced into the environment. A common way that oxygen is introduced into the environment is when a door or window is opened. There are two types of ventilation: horizontal and vertical. Horizontal ventilation is the first choice as it provides better results, and causes less property damage. Horizontal ventilation is achieved by cutting a hole into the roof of the burning structure. The size of the hole is typically 4 feet by 4 feet.

The current methods and apparatuses that are used to preform horizontal ventilation are filled with problems. The traditional method of roof ventilation, using an ax or similar tool such as the tools outlined in U.S. Pat. No. 20130263710 and U.S. Pat. No. 5,165,659, is a long process that endangers firefighters because they are on a burning structure for extended periods of time.

While some fire departments now use gas powered chainsaws to accomplish the task, the firefighters are still on the roof for several minutes. The chainsaws also add one more problem. Because of the high smoke environment that the saws are used in, they have a shorted lifespan which is costly to fire departments, and has led to malfunctions while the firefighters one the roof Although the apparatus described U.S. Pat. No. 6,298,945 tried to solve some of the issues of roof ventilation by keeping fire fighters off the roof, that apparatus can cause massive structural damage to buildings. This endangers the live of firefighters who are entering the building as well as prospective occupants. Furthermore, it requires a ladder truck to operate, which means that buildings that are not close to the road are not able to be vented by that apparatus.

### BRIEF SUMMARY OF THE INVENTION

The Robotic Roof Ventilation Apparatus of the present invention solves the issues that are currently presented by the current methods and apparatuses of roof ventilation. The present invention is a medium sized robot that is easily carried by one or two persons. To use the robot firefighters simply attach it to the ladder via a clasp system, and then lean the ladder on the roof They start the robot by using their RFID card. Once the correct RFID card has been to presented to the robot it will ascend the ladder. Once on the roof the robot will cut the desired 4 foot by 4 foot hole. Once the hole is completed the robot will then navigate back to the ladder, and wait for retrieval. While cutting the roof the robot will be monitoring the depth of the cut to ensure the blade does not erroneously cut a truss which will damage the structure of the building. Furthermore, the body of the robot will be airtight which will ensure that smoke does not enter the equipment. The present invention solves many issues including the danger of firefighters staying on the roof, shortened equipment life, excessive damage of the roof, and portability.

### BRIEF DESCRIPTION OF THE SEVERAL VIEWS OF THE DRAWING

FIG. 1 is a view of the robot making a cut into the roof

FIG. 2 is a side view of the robot ascending the ladder.

FIG. 3 is a side view of the robot on the roof before making a cut.

FIG. 4 is a flow chart illustrating the electrical components of the robot.

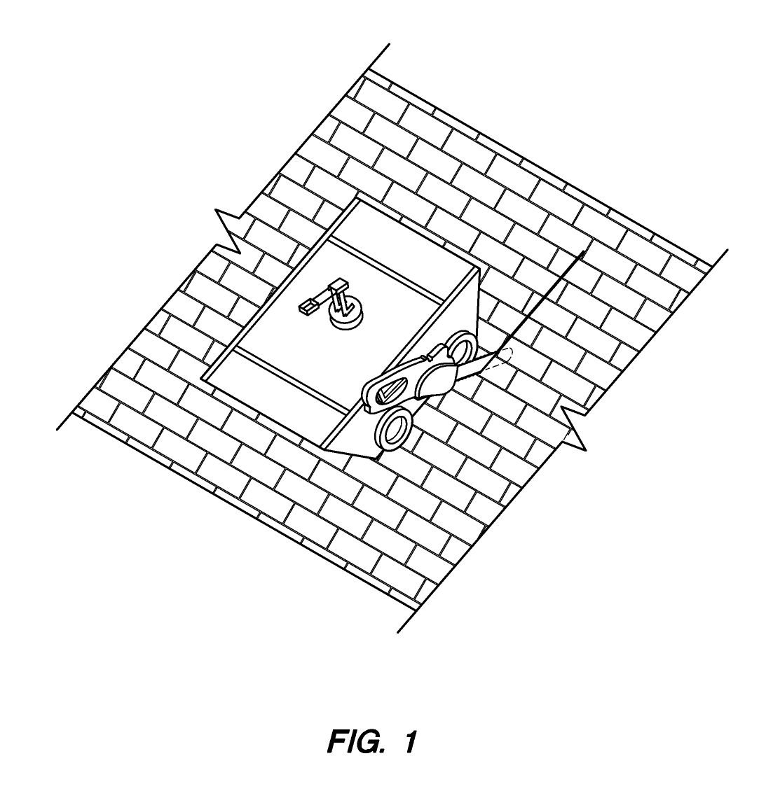

### DETAILED DESCRIPTION OF THE INVENTION

The Robotic Roof Ventilation Apparatus, of the present invention, in essence, comprises generally of: electrical components, mechanical components, and stationary components.

The electrical components consist of a control unit [29], inputs, outputs, power supply unit, and the components for video transmission.

The inputs are sensors that will be continually feeding raw data, using both digital and analog signals, to the control unit [29]. The control unit [29] will be programmed to complete the process of roof ventilation in a series of steps. Before moving on to the next step the control unit [29] will ensure that the conditions are correct inside the robot, and externally by using the incoming data. As the control unit [29] moves the robot through the steps of roof ventilation it will need to use the outputs for anything that requires motion. The control unit [29] will use its built-in high powered transistors, and H-bridges to control the outputs. Furthermore, the control unit [29] will have the option to abort the mission. Examples that would force an abortion of the mission include: the temperature on the roof is starting to exceed the robots maximum operating temperature, large bursts of flames on the roof, or a stop signal coming from the ground that has been transmitted by the operator. The above situations would come to the control units [29] notice via the temperature sensor [7], IR sensor [4] or wireless RX [10] respectively.

The power supply is another electrical component. Its very simple and will consists of a small bank of rechargeable batteries [27], and an appropriate battery charger [28]. The rechargeable battery [27] will send power to the control unit [29], and the camera [11]/transmitter [12] when the robot is turned on. The battery charger [28] will be inside of the robot making it easy to recharge the robot. Unlike some devices that require the removal of batteries to charge the device, the user will simply plug a wire coming form the robot into a standard American electrical outlet running at 125 v Ac.

The final electrical components are the video transmitter [12] , and camera [11]. When the robot is powered on, the video transmitter [12] will transmit live video from the camera [11] so that firefighters can evaluate the situation on the roof without having any personal on it.

The main mechanical components consist of saw components, wheel [37], and the components required to ascend the ladder.

The mechanical saw components include the blade [35], body [36], lever [34], and gear box. The lever [34] will be inside an oval cut out towards the back of the saw's body [36]. As the lever [34] moves up and down the saw blade [35] will do the same. The blade [35] will be connected to a gear box which will be connected to the motor [18]. Its important to note that in the images the saw is depicted as a chain saw, but the robot may use any type of saw blade that is deemed suitable for roof ventilation. The components would remain the same, but the blade [35] would be different.

Each wheel [37] will be connected to an axel which will each be connected to one of the drive motors [16-1] [16-2] [16-3] [16-4]. Its important to note that the images depict a four wheel drive robot, but the robot could also contain a track system. The operation would be the same.

The mechanical components for ascending the ladder include a S-hook that clips onto the top rung of a ladder that will, hereafter, be called “clip” [30]. The other components is a wire braided rope that, hereafter, will be called “rope” [31].

The main stationary components include a u-bolt, insulation, and the robot's body [33]. The u-bolt will be placed on the underside of the robot centered in-between the two back wheels [37]. The robot's body will be constructed of metal or another material that has a high melting point. The insulation will be inside the robot and cover the entire body which will help keep the electrical components from being exposed to high temperatures.

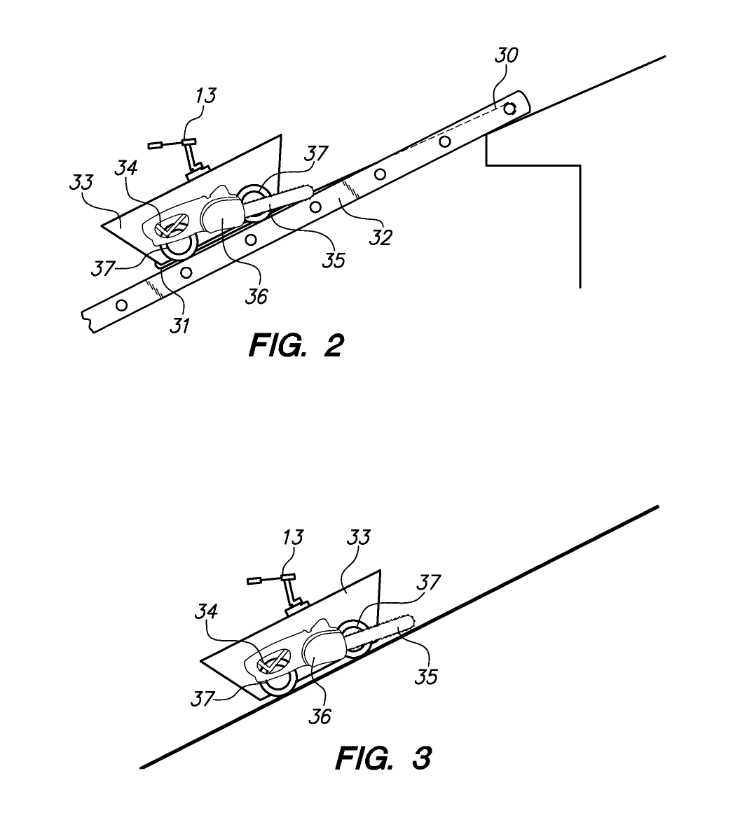

The Robotic Roof Ventilation Apparatus of present invention in preferred embodiment starts the first step of roof ventilation by ascending the ladder [32] as shown in FIG. 2. To understand how the robot ascends the ladder [32] its essential that it is understood how the components link together. The winch [24] is attached to a rope [31] which has a clip [30] on the other end of it. The clip [30] is manually attached to the top rung of any standard firefighting ladder [32]. The robot is prevented from tipping backwards off the ladder [32] as the rope [31] passes under a small U-bolt who's location was previously described in paragraph [0029]. The operator starts the process of roof ventilation by attaching the clip [30] to the top rung of the ladder [32]. The operator then leans the ladder against the roof; at this point the robot will be at the bottom of the ladder [32] with its wheels [37] hanging off the edge. Then the operator places their RFID card near the robots RFID reader [6]. After the control unit [29] verifies that correct RFID card was shown the winch [24] will start pulling the robot up the ladder [32]. Its important to note that the drive system [15] and thus wheels [37] will remain idle while the winch [24] is puling the robot up the ladder [32]. As the front of the robot is pulled off the top of the ladder the gyro's [5] signals will change because of the downward motion and the control unit [29] will activate the front motors [16-1] [16-2] which will active the front wheels [37]. After a short preset duration of time the control unit [29] will turn the winch [24] off. The front wheels will pull the back wheels [37] the rest of the way onto the roof. Once the back of the robot lands on the roof the gyro's [5] signal will change again and the control unit [29] will engage the back motors [16-3] [16-4] which will power the back wheels [37]. The robot will pull a small distance up the roof, and then the control unit [29] will stop the drive system [15].

Once the robot is stopped the control unit [29] will closely monitor the signals coming from the distance sensors [8-1] [8-2] which are mounted in the front of the robot's body [33]. If the control unit [29] determines that there are any chimneys, pipes, vents or any other sizable object in the way of the cutting path the control system [29] will use the drive system [15] to activate the wheels [37] to move the robot over a few feet. The control unit [29] will keep moving the robot via the drive system [15] and wheels [ 37] until a clear space is found. Once a clear space is found, or if the robot was in a clear space to begin with, the control unit [29] will start the process of cutting into the roof via cutting system [17] and mechanical components [34] [35] [36]. Using lever [34] and motor [18], the saw blade [35] will be lowered towards the roof. Once the blade [35] is hovering above the roof the saw motor [19] will engage and the blade [35] and the saw will began to cut a hole as the lever [34] pushes the blade [35] into the roof. The control unit [29] will be monitoring the amperage sensor [9-5] to detect if the cutting system [17] is cutting into a truss or the shingles/plywood. If the blade [35] is cutting into the truss the saw blade [35] will be raised slightly until it is only cutting the plywood and shingles. After that the control unit [29] will activate the drive system [15]. The control unit, [29] monitoring the signals coming from the encoders [1-1] [1-2] [1-3] [1-4] on each wheel [37] and accelerometer, [3] will use the drive system [15] and wheels [37] to propel the robot 4.2 feet. Once that distance has been reached the saw blade [35] will be lifted out of the roof using the same components that lowered it into the roof. After that the control unit [29] will back the robot up 0.2 feet by way feet and then make a 90 degree turn using the drive system [15] and wheels [37]. It will use the compass [2], and encoders [1-1] [1-2] [1-3] [1-4] to ensure that the turn is precise. The robot will repeat the process of cutting and turning until the desired 4 foot by 4 foot hole is completed.

Once completed the control unit [29] will use a distance sensor [8-3] which is mounted on the camera arm [13] to inspect the hole. Using servos [14-1] [14-2] [14-3] [14-4] the control unit [29] will move the camera arm [13] around to ensure that the roofing material fell though. If it did the robot will return to the ladder again using its drive system [15] and wheels [37] and wait for retrieval. If not, the control unit [29] will utilize linear actuator [20] to push the material into the building. Its important to note that the linear actuator [20] is located on the side of the robot opposite of the cutting system [17] and when activated by the control unit [29] the movable rod in the linear actuator [20] will press onto the cut portion of the roof causing it to fall in. After that the robot will then return to the ladder, and wait for retrieval. At that point the display [25] will flash the time it took to complete the roof ventilation and other potentially useful data so that once the firefighters recover the robot they will be able to log the data to help them study the art of firefighting.

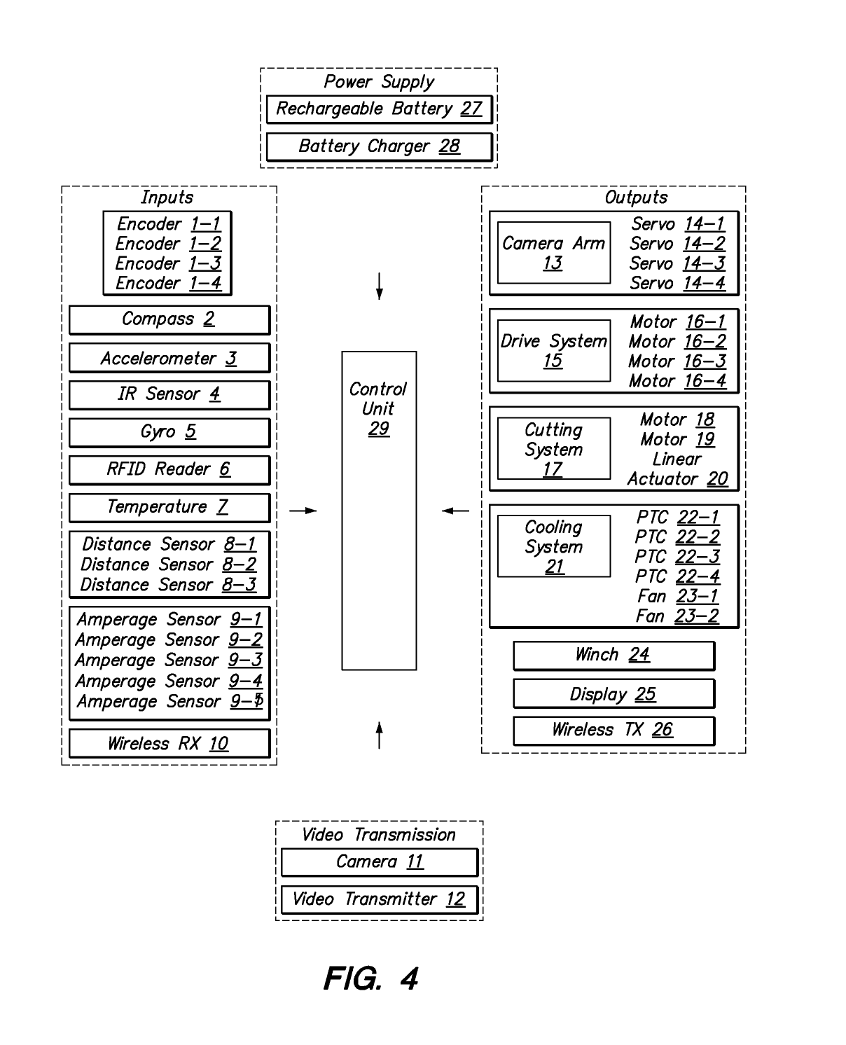

While the processes described in paragraphs [0030], [0031], and [0032] is happening, the control unit [29] will be doing a few other tasks at the same time. As described in paragraph [0022] the control unit [29] will be monitoring the inputs to see if the mission needs to aborted. The control unit [29] will also be monitoring the amperage sensors [9-1] [9-2] [9-3] [9-4] and temperature sensor [7] for signs that it needs to utilize the cooling system [21]. Each of the amperage sensors [9-1] [9-2] [9-3] [9-4] are connected to one of the motors [16-1] [16-2] [16-3] [16-4]. By monitoring the signals coming form the amperage sensors [9-1] [9-2] [9-3] [9-4] the control unit [29] will be able to determine the general pitch of the roof. If the pitch of the roof is very steep the control unit [29] will turn on the Peltier Coolers (refried to as PTC in FIG. 4) [22-1] [22-2] [22-3] [22-4]. Each of the Peltier Cooler [22-1] [22-2] [22-3] [22-4] is attached to one of the drive motors [16-1] [16-2] [16-3] [16-4]. When turned on, the Peltier Cooler [22-1] [22-2] [22-3] [22-4] will help keep the drive system [15] from over heating. Another trigger for the Peltier Coolers [22-1] [22-2] [22-3] [22-4] would be if the temperature sensor [7] is showing that the temperature is quickly rising inside the robot. If the temperature keeps rising the control unit [29] will turn on the fans [23] in a effort to avoid abortion of the mission due to excessive heat. Another thing that the control unit [29] will be monitoring is the wireless Rx [10] for a change of command signal. If it receives that it will turn over control to the operator on the ground who will have a remote control. The robot wireless TX [26] will be used so that the robot can remained linked to the remote control on the ground. The final thing the control unit [29] will be monitoring is for a sudden drop or kill command. By combing data from its various inputs the control unit [29] will be able to determine if it falls through the roof. If the robot does fall though the control unit [29] will shut off the drive system [15] and cutting system [17] so that it lessens the danger for anybody inside the building. Furthermore, if the control unit [29] receives a kill command which is different from the stop command described in paragraph [0022] it will again shut off its drive system [15] and cutting system [17].

Closing Statement:

Having thus described in detail a preferred embodiment of the Robotic Roof Ventilation Apparatus of the present invention, it is to be appreciated and will be apparent to those skilled in the art that many changes not exemplified in the detailed description of the invention could be made without altering the inventive concepts and principles embodied therein. It is also to be appreciated that numerous embodiments incorporating only part of the preferred embodiment are possible which do not alter, with respect to those parts, the inventive concepts and principles embodied therein. The presented embodiments are therefore to be considered in all respects exemplary and/or illustrative and not restrictive, the scope of the invention being indicated by the appended claims, and all alternate embodiments and changes to the embodiments shown herein which come within the meaning and range of equivalency of the appended claims are therefore to be embraced therein.

I claim:

1. A robotic roof venting apparatus used for the task of roof ventilation comprising:
a fire-resistant frame
a internal cooling system
a system to travel up a ladder
a method of traversing the roof
a means to cut the roof
a visual feed back system that can provide the firefighters with live video during and after the cut.
a group of sensors that provides environmental an internal data.
a processing system able to interpret incoming sensor data and respond to them.

2. The apparatus as defined in claim 1 where the cutting method is by a gas powered saw

3. The apparatus as defined in claim 1 where the cutting method is by an electric powered saw

4. The method of traversing the roof in claim 1 where the drive system is comprising of a wheeled system

5. The method of traversing the roof in claim 1 where the drive system is comprising of a track system

6. The robot in claim 1 possesses the ability to operate via remote control or autonomously.
